(19) United States
(12) Patent Application Publication
(10) Pub. No.: US 2020/0102894 A1
(43) Pub. Date: Apr. 2, 2020

(54) ANTI-SURGE AND RELIGHT SYSTEM

(71) Applicant: Rolls-Royce North American Technologies Inc., Indianapolis, IN (US)

(72) Inventors: Robert Duge, Carmel, IN (US); Michael Karam, Plainfield, IN (US)

(73) Assignee: Rolls-Royce North American Technologies Inc., Indianapolis, IN (US)

(21) Appl. No.: 16/146,024

(22) Filed: Sep. 28, 2018

(51) Int. Cl. F02C 9/28; F02B 21/00; F02C 7/262; F04D 27/02

(52) U.S. Cl. CPC F02C 9/28; F02B 21/00; F02W 2746/00973; F04D 27/0223; F02C 7/262

(57) ABSTRACT

Systems and methods are provided that use compressed gas from a tank in an aircraft to avoid and/or recover from a compressor surge. Systems and methods are provided that use compressed gas from a tank to startup a gas turbine engine in an aircraft, where the gas turbine engine is configured as a prime power engine for the aircraft.

### TECHNICAL FIELD

This disclosure relates to engines and, in particular, to gas turbine engines.

### BACKGROUND

Present gas turbine engines suffer from a variety of drawbacks, limitations, and disadvantages. Accordingly, there is a need for inventive systems, methods, components, and apparatuses described herein.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 is a schematic diagram of an example of a compressed gas power and thermal management system that uses compressed gas from a tank to both cool a load and drive a turbine;

FIG. 2 illustrates an example of a system in which a heat exchanger is in fluid communication with a turbine via a combustor;

FIG. 3 is a schematic diagram of an example of a compressed gas power and thermal management system that includes two engines;

FIG. 4 illustrates another example of a compressed gas power and thermal management system;

FIG. 5 illustrates a portion of a system that includes additional components;

FIG. 6 illustrates a flow diagram of example steps for providing power and thermal management;

FIG. 7 is a schematic diagram of an example of an anti-surge and relight system for one or more gas turbine engines of an aircraft;

FIG. 8 is a cross-sectional view of an example of a gas turbine engine; and

FIG. 9 illustrates a flow diagram of example steps for avoiding compressor surge, recovering from compressor surge, and/or starting a gas turbine engine.

### DETAILED DESCRIPTION

Typical gas turbine engines may experience operational problems at high altitudes, such as altitudes greater than 40,000 feet. In some examples, such problems may be encountered at high altitudes of 30,000 feet or greater. Examples of such problems include compressor surge and combustion flame out.

Compressor surge refers to a condition in the gas turbine engine in which inlet pressure conditions do not support the normal operation of the engine. A reversal of fluid flow may occur in the engine during the surge condition. A compressor surge may cause a variety of well-known engine problems. For example, the compressor surge may cause disruption of engine propulsive force, and, in some cases, damage to the engine.

A compressor operating map for a particular gas turbine engine may identify various operating regions of the compressor on a graph showing pressure ratio versus mass flow. The mass flow is an indication of the amount of mass of the fluid that is flowing through the compressor. The pressure ratio may be the ratio of the outlet pressure to the inlet pressure, where the outlet pressure is the pressure of the fluid at the outlet of the compressor, and the inlet pressure is the pressure of the fluid at the inlet of the compressor. The compressor operating map may include a surge line, which may have a positive slope in some examples. In such examples, the area above the surge line may be an operating region in which the pressure ratio is effectively too high, resulting in the compressor experiencing a compressor surge. In other words, the pressure becomes high enough at the outlet of the compressor that the fluid flow reverses, and flows back toward the inlet of the compressor, which is at a low enough pressure relative to the outlet pressure to induce the flow reversal.

Gas turbine engines are typically operated with a surge margin in order to prevent an inadvertent occurrence of a compressor surge. In other words, the compressor is operated far enough below the surge line that typical changes in the pressure ratio does not result in crossing the surge line. However, at high altitudes, where the ambient pressure is very low, and consequently, the inlet pressure is very low, the pressure ratio may become high enough to result in a surge. Indeed, a relatively small perturbation at high altitude may cause the pressure ratio to cross the surge line.

In addition, another problem that occurs at high altitudes due to the low air pressure is that the combustor may flame out. Restarting the gas turbine engine at the low pressures that are present at high altitudes may be a difficult task. In some cases, the aircraft may need to coast down to a lower altitude where sufficient air pressure exists for a restart. This may prevent the aircraft from performing, for example, a high altitude surveillance mission.

Systems and methods are described herein that help prevent and/or recover from a compressor stall. In addition, systems and methods are described herein that enable a mid-air startup and/or a high-altitude startup of the gas turbine engine, if, for example, a flame out occurs.

Typical heat engine power solutions also may have problems at high altitudes. In particular, engines may be de-rated due to very low ambient air pressure, making it difficult to provide a relatively large amount of electrical power at higher altitudes using a typical heat engine to drive a generator. If an engine is sized to provide the electrical power just mentioned in addition to powering an aircraft at such altitudes, then the engine may be oversized for other operating conditions, such as at lower altitudes, resulting in being less fuel efficient under other operating conditions. Counterintuitively, it may also be difficult to provide cooling of electronics at extremely high altitudes—there may not be enough air flow to allow effective heat exchange with conventional systems.

Systems and methods are described herein that use compressed gas (such as compressed air) to drive a turbine, which powers a generator, where excess cooling capacity from the expanded gas may cool an electrical load that is powered by the generator. The system may be included in an aircraft, for example. For example, the system may be included in a fuselage, a wing, a nose, or any other part of the aircraft. The system may have other applications as well, and not necessarily at higher altitudes. For example, the system may be a portable system carried by a person. Such a system may be worn, for example, on a person's back. In some examples, the system may be arranged in a backpack. As another example, the system may be included in a land or water based vehicle such as a truck or a boat.

In one example, a power and thermal management system is provided that includes a tank of compressed gas, a heat exchanger, a turbine, and an electric generator. The heat exchanger is configured to receive a portion of the compressed gas from the tank at a lower pressure than in the tank. The turbine is configured to be driven by the compressed gas from the tank that passes through the heat exchanger. The electric generator is configured to be mechanically powered by the turbine. The system is configured as a primary electric power source for a load external to the power and thermal management system, and the heat exchanger is configured to cool the load from an expansion of the compressed gas released from the tank.

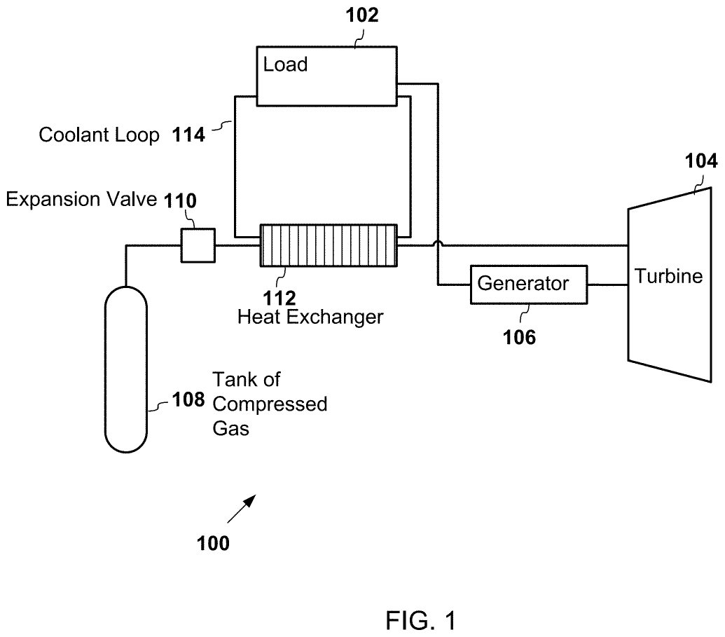

FIG. 1 is a schematic diagram of an example of a compressed gas power and thermal management system 100 that uses compressed gas from a tank 108 to both cool a load 102 and drive a turbine 104. The turbine 104 powers a generator 106, which generates electricity for the load 102. The system 100 in the example shown includes the tank 108 of compressed gas, an expansion valve 110, a heat exchanger, the turbine 104, and the generator 106.

The system 100 illustrated in FIG. 1 may be an integrated power and thermal management system. An integrated power and thermal management system (IPTMS) is considered “integrated” because electrical power generated by the IPTMS may power one or more devices within the IPTMS, such as components of the thermal management system. Alternatively or in addition, the thermal management system may cool and/or heat components of the power management/generation system, such as the power electronics, the gearbox, generator, or any other component of the power management/generation system.

Alternatively, the system 100 may not be an integrated power and thermal management system. For example, the thermal management components of the system 100, such as the heat exchanger 112 and the coolant loop 114, may not cool any component of the power management/generation system, such as the generator 106 and the turbine 104, and the power management/generation components of the system 100 may not power any component of the thermal management system.

The load 102 may include any device or combination of devices that consumes electricity that may benefit from cooling and/or heating, and which is not part of the system 100. The load 102 excludes any component of the system 100 that generates or prepares electricity for delivery and further excludes any component of the system 100 that provides or manages cooling. Examples of the load 102 may include solid state electronics, a light-emitting diode (LED), an analog circuit, a digital circuit, a computer, a server, a server farm, a data center, a circuit that imposes a hotel load such as vehicle electronics, a circuit that imposes a primary load, a component of an aircraft, avionics, a directed-energy weapon, a laser, a plasma weapon, a railgun, a microwave generator, a pulse-powered device, a satellite uplink, an electrically powered machine, an electric motor, and any other electronic device that may benefit from heating and/or cooling. Examples of the directed-energy weapon may include a microwave weapon, a laser weapon, a pulsed energy projectile, a dazzler, a particle-beam weapon, a plasma weapon, and a sonic weapon.

The system 100 may be configured as a sole power source or a primary power source for the load 102. Alternatively, the system 100 may be configured as a backup power source or a supplementary power source for the load 102. The system 100 is configured as a primary power source for the load 102 if the system 100 is configured to power to the load 102 under typical operation of the load 102 and, under typical operation of the load 102, less than 85 percent of the electric power provided to the load 102 comes from any power source (or combination of power sources) that do not rely on compressed gas from a tank to power a turbine. The system 100 is configured as a sole power source if no other power source is configured to provide power to the load 102.

The tank 108 of compressed gas may be in fluid communication with the expansion valve 110, which in turn may be in fluid communication with an inlet of the heat exchanger 112. An outlet of the heat exchanger may be in fluid communication with the turbine 104. The turbine 104 may be mechanically coupled to the generator 106 such that the turbine 104 may drive the generator 106. The generator 106 may be electrically coupled to load 102. The heat exchanger 112 may be configured to transfer heat, for example via cooling fluid in a coolant loop 114, from the load 102 to the gas within the heat exchanger 112.

During operation of the system 100, compressed gas in the tank 108 expands as the gas passes through the expansion valve 110. The gas may cool substantially as a result of expanding through the expansion valve 110. For example, the cooled, expanded gas may be around minus 200 degrees Fahrenheit. The cooled, expanded gas may pass through the heat exchanger 112, thereby cooling the cooling fluid in the coolant loop 114 in order to cool the load 102 either via the cooling fluid directly as shown or through one or more thermal management components (not shown). Alternatively or in addition, the heat exchanger 112 may transfer heat from the load 102 to the expanded gas in the heat exchanger 112 using any other mechanism.

The gas exiting the heat exchanger 112 may be warmer than the gas that entered the heat exchanger 112 as a result of the heat transferred from the load 102 to the gas in the heat exchanger. Although at a lower pressure than the gas in the tank 108, the gas exiting the heat exchanger 112 may still be compressed as compared to the ambient gas or air in the atmosphere around the system 100. This compressed gas may flow past blades in the turbine 104 and into ambient gas or air in the atmosphere. As a result, the blades may rotate a rotor in the turbine 104, which in turn mechanically powers the generator 106 so that the generator 106 generates electricity. The electricity generated by the generator 106 may be supplied to the load 102. In other words, during the operation of the system 100, the system 100 uses the compressed gas in the tank 108 to electrically power the load 102 and thermally cool the load 102.

The turbine 104 may be any device or machine configured to transfer kinetic energy of fluid into rotational energy. Alternatively or in addition, the turbine 104 may be any device that extracts energy from a continuously moving stream of fluid. The turbine 104 may be a device comprising a rotor and one or more blades coupled to the rotor, where the rotor is configured to rotate if fluid, such as a gas, flows sufficiently fast past the one or more blades. The turbine 104 may be an axial flow machine, a radial flow machine, or any other design.

The generator 106 may be any electric generator. The generator 106 may be any device that converts motive power into electrical power. Examples of the generator 106 include a direct current (DC) generator and/or an alternating current (AC) generator.

The tank 108 for holding the compressed gas may be any vessel configured to hold gas at a pressure higher than outside of the vessel. The tank 108 may be made of metal, metal alloy, glass, or any other material suitable for containing one or more gases in the tank 108. The tank 108 may be cylindrical, round, or any other shape. Examples of the gasses may include air, oxygen, carbon dioxide, or any other gas.

The heat exchanger 112 may be any device configured to transfer heat between fluids or to transfer heat between a gas and a fluid. Examples of the heat exchanger 112 may include air-to-air heat exchanger, air-to-fluid heat exchanger, a shell and tube heat exchanger, a plate heat exchanger, a plate and shell heat exchanger, a plate fin heat exchanger, a microchannel heat exchanger, a micro heat exchanger, a micro-scale heat exchanger, a microstructured heat exchanger, a direct contact heat exchanger, or any other type of heat exchanger.

The coolant loop 114 may include any a cooling path through which a coolant may circulate. The coolant may be any suitable coolant, such as air, water, inert gas, water-based coolant, oil, ethylene glycol, diethylene glycol, propylene glycol, polyalkylene glycol, Freon, refrigerant, anhydrous ammonia, or any other type of coolant.

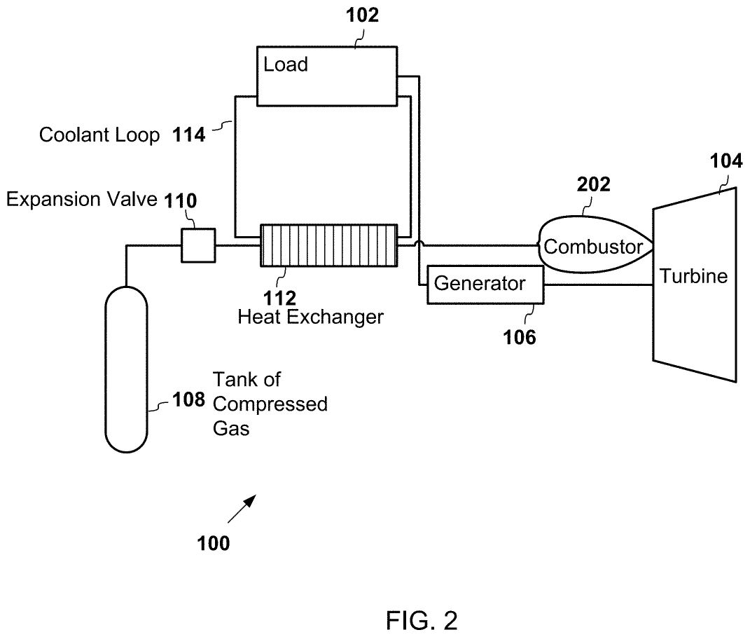

The system 100 may be implemented in many different ways. For example, FIG. 2 illustrates an example of the system 100 in which the heat exchanger 112 is in fluid communication with the turbine 104 via a combustor 202. During operation of the system 100, the compressed gas from the tank 108 flows through the expansion valve 110 and into the heat exchanger 112 just as in the example shown in FIG. 1. However, in the example shown in FIG. 2, the compressed gas leaving the heat exchanger 112 flows into the combustor 202. The compressed gas in the combustor 202 is injected with a fuel and the fuel is burned. The resulting exhaust gas from the combustor 202 then drives the turbine 104. The fuel may be any type of jet fuel or other fuel suitable for burning in the combustor 202.

The combustor 202 may be a component where combustion takes place. The combustor 202 may also be referred to as a combustion chamber and/or a burner. The combustor 202 may be configured to mix and ignite the compressed gas and fuel. In some examples, the combustor 202 may include one or more fuel injectors, swirlers, and or other components. Examples of the combustor 202 may include a can combustor, an annular combustor, a cannular combustor, or any other configuration of combustor.

The combination of the combustor 202 and the turbine 104 may be referred to as an engine. For example, the combustor 202 and the turbine 104 may be components of a gas turbine engine. The engine may or may not include a compressor. The engine does not necessarily include the compressor because the engine may receive compressed gas from the tank 108 instead from a compressor.

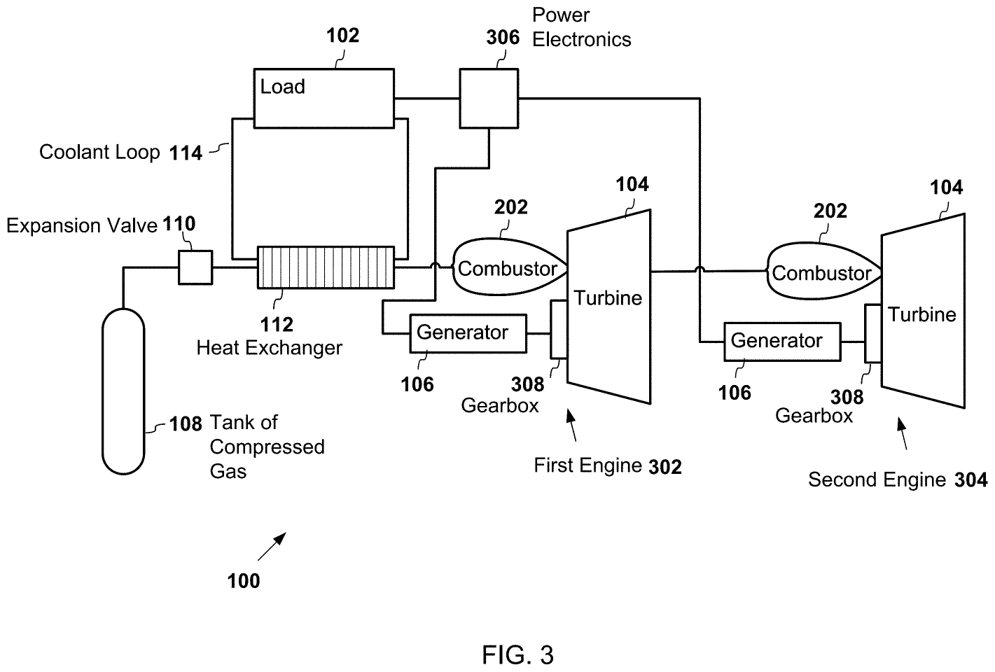

FIG. 3 is a schematic diagram of an example of the compressed gas power and thermal management system 100 that includes two engines 302 and 304, each of which includes a corresponding combustor 202 and a corresponding turbine 104. The example of the system 100 shown in FIG. 3 includes the tank 108 of compressed gas, the expansion valve 110, the heat exchanger 112, the two engines 302 and 304, two generators 106, power electronics 306, and two gearboxes 308.

During operation of the system 100 shown in FIG. 3, the compressed gas from the tank 108 flows through the expansion valve 110 and into the heat exchanger 112 just as in the example shown in FIG. 1. However, in the example shown in FIG. 3, the compressed gas leaving the heat exchanger 112 flows into the combustor 202 of the first engine 302. The fuel fed into the combustor 202 may mix with the compressed gas, burn, and gas exiting the combustor 202 powers the turbine 104 of the first engine 302.

Exhaust gas from the first engine 302 may flow into the combustor 202 of the second engine 304. The exhaust gas that enters the second engine 304 may still be compressed relative to the ambient air around the system 100. This compressed exhaust gas may flow into the combustor 202 of the second engine 304, where fuel is mixed with the compressed gas, burned, and gas exiting the combustor 202 powers the turbine 104 of the second engine 304.

Each of the turbines 104 may power a corresponding one of the generators 106 through, for example, a corresponding one of the gearboxes 308. The generators 106 may in turn generate electricity that is supplied to the load 102 through, for example, the power electronics 306. The power electronics 306 may modify and/or combine the electricity generated by the generators 106. For example, the power electronics 306 may convert AC from the generators 106 into DC. In some examples, one of the generators 106 may generate AC and the other may generate DC. In other examples, both of the generators 106 may generate AC. Alternatively, both of the generators 106 may generate DC.

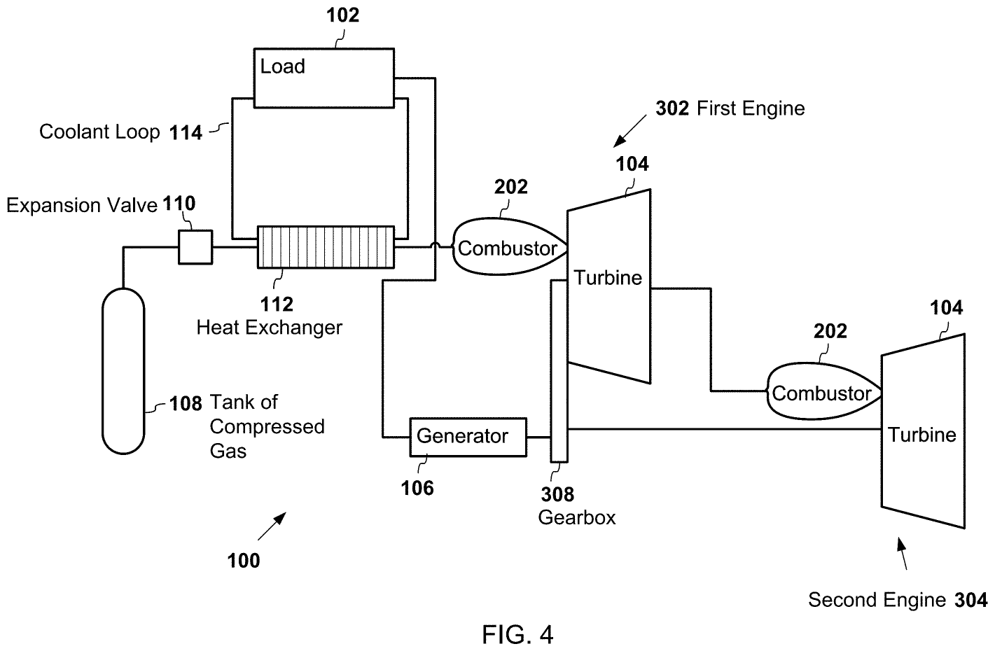

However, the system 100 may include any suitable number of the generators 106, the gearboxes 308, and/or the power electronics 306. For example, FIG. 4 illustrates an example of the system 100 that does not include the power electronics 306 and includes only one generator 106 and only one gearbox 308. The turbines 104 may have turbine drive shafts geared together so as to power the single generator 106. The electricity generated by the generator 106 may be provided directly to the load 102. In some examples of the system 100 that include multiple generators 106, the generators 106 may be synchronized using any suitable synchronization mechanism so that the generators 106 each output alternating current (AC) that is in phase with the AC that is generated by the other respective generators.

The examples of the system 100 shown in FIG. 3 and FIG. 4 each includes the two engines 302 and 304. In other examples, the system 100 may include n number of the engines 302 and 304, where n is an integer greater than zero. In some configurations, the more engines 302 and 304 that are included in the system 100, the more efficiently the system 100 will be able use the compressed gas. Alternatively, the fewer engines 302 and 304 included in the system 100, the less efficiently the system 100 will be able to use the compressed gas. The more efficient the use of the compressed gas, the longer the compressed gas may last—assuming that the power output is held constant. On the other hand, the more engines 302 and 304 that are included in the system 100, the less efficient the system 100 may use fuel; and conversely, the fewer the engines 302 and 304 that are included, the more efficiently the system will use fuel. However, efficiency may depend on many factors, so these general rules about efficiency may not apply in some configurations.

Alternatively, the system 100 may not include any engines 302 and 304 that include the combustor 202. In this so-called “zero burner” configuration, the system 100 includes one or more turbines 104 none of which include any corresponding combustor 202. The example shown in FIG. 1 is one such “zero burner” configuration. In a “zero burner” configuration, the turbines 104 may be “chained together” in some examples. When “chained together,” the turbines 104 may be arranged so that the gas exiting each one of the turbines 104 flows into the next turbine 104 in the chain until the gas exits the last turbine 104 in the chain. In some examples, one or more turbines 104 without a corresponding combustor 202 and/or engines 302 and 304 comprising the turbine 104 and the combustor 202 may be chained together.

In some examples, the system 100 may use the cooled, expanded gas downstream of the expansion valve 110 to provide cooling for components other than the load 102, such as the generator(s) 106 and the power electronics 306. At the same time, the expanded gas may be powering the turbine(s) 104. Powering the turbine(s) 104 may mean directly powering, such as in the example shown in FIG. 1, or indirectly, such as in the examples shown in FIGS. 3 and 4.

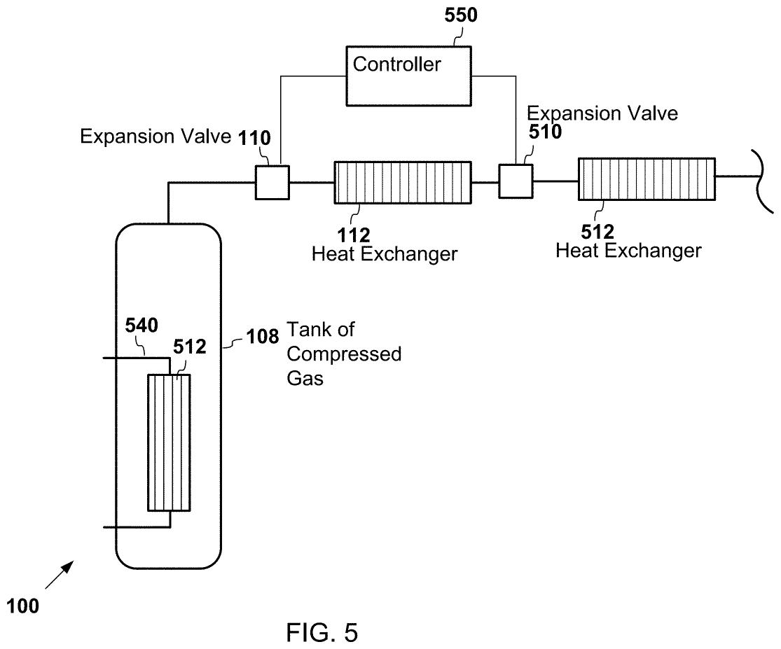

The system 100 may include additional, different, and/or fewer components than shown in the examples illustrated in FIGS. 1 to 4. For example, FIG. 5 illustrates a portion of the system 100 that includes additional components, any of which may be used in combination with the components in any of the other examples described herein. The additional components shown in FIG. 5 include a second expansion valve 510 positioned downstream of the first heat exchanger 112, a second heat exchanger 512 positioned downstream of the second expansion valve 510, a third heat exchanger 512 arranged in the tank 108 of compressed gas, and a controller 550 configured to control one or more of the expansion valves 110 and 510.

The third heat exchanger 512, which is located inside of the tank 108 of compressed gas, may be used to warm the gas in the tank 108 and, conversely, be used as a source of cooling. As the gas leaves the tank 108 through the first expansion valve 110, the temperature of the gas in the tank 108 may drop. The heat exchanger 512 in the tank 108 may leverage that cooling effect to cool the load 102 or any other thermal load. In addition, heat transferred to the gas in the tank 108 via the heat exchanger 512 in the tank 108 may help avoid the compressed gas in the tank 108 from liquefying through a drop in temperature. A coolant loop 540 (only part of which is shown in FIG. 5) may transfer the heat to the heat exchanger 512 in the tank 108 from some other component, such as the load 102.

By adjusting the flow of the gas through the first and second expansion valves 110 and 510, the pressure drop through each of the expansion valves 110 and 510 may be controlled by, for example, the controller 550. As a result, the cooling capacity of each of first heat exchanger 112 and second heat exchanger 512 may be controlled. Alternatively, if the system 100 did not include the second heat exchanger 512, then the cooling capacity of the first heat exchanger 112 may be controlled even if the amount of compressed gas flowing through the second expansion valve 510 to the turbine 104 and/or engine 302 or 304 is varied over time. For example, the controller 550 may adjust the flow of the compressed gas through the first and second expansion valves 110 and 510 so as to maintain a substantially constant pressure drop between the first and second expansion valves 110 and 510 even though the amount of compressed gas flowing through the second expansion valve 510 to the turbine 104 and/or engine 302 or 304 is varied over time. In one such example, as the amount of compressed gas flowing through the second expansion valve 510 is increased, the amount of compressed gas flowing through the first expansion valve 110 may also be increased.

The amount of mechanical power generated by the turbine 104 may be controlled by adjusting the amount of compressed gas that flows to the turbine 104. For example, the controller 550 may adjust the amount that flows through the first expansion valve 110 and/or the second expansion valve 510. The controller 550 may adjust, for example, a size of an opening through the first expansion valve 110 and/or the second expansion valve 510 so that a target flow rate to the turbine 104 corresponds to a target power level of the turbine 104.

Even though two expansion valves 110 and 510 and two heat exchangers 112 and 512 are shown arranged in series in FIG. 5, any number of expansions valves 110 and 510 and heat exchangers 112 and 512 may be arranged in parallel or in series. Each of the heat exchangers 112 and 512 may be used to cool the load 102 and/or any other thermal load.

The controller 550 may be any device that performs logic operations. The controller 550 may be in communication with a memory (not shown). The controller 550 may include a controller, engine control unit (ECU), engine control module (ECM), a general processor, a central processing unit, a computing device, an application specific integrated circuit (ASIC), a digital signal processor, a field programmable gate array (FPGA), a digital circuit, an analog circuit, a microcontroller, any other type of processor, or any combination thereof. The controller 550 may include one or more elements operable to execute computer executable instructions or computer code embodied in the memory.

The memory may be any device for storing and retrieving data or any combination thereof. The memory may include non-volatile and/or volatile memory, such as a random access memory (RAM), a read-only memory (ROM), an erasable programmable read-only memory (EPROM), or flash memory. Alternatively or in addition, the memory may include an optical, magnetic (hard-drive) or any other form of data storage device.

In some examples, the exhaust gas from the engine 302 or 304 (or from the last engine 302 or 304 in a series or chain) may operate to provide additional thrust from the engine 302 or 304. Similarly, the exhaust gas exiting the turbine 104 may provide additional thrust even if the turbine 104 is not paired with the combustor 202 and/or the system 100 is a “zero burner” configuration.

Alternatively or in addition, the exhaust gas may be used to create a condensation cloud. For example, the system 100 may include a water tank (not shown) from which water droplets may be sprayed into the exhaust gas to form the condensation cloud. The condensation cloud may be used for any purpose, such as signaling and/or as a countermeasure.

In some examples, carbon dioxide may be removed from the tank of compressed gas. Removing the carbon dioxide may help prevent liquification of carbon dioxide, allowing colder temperatures to be attained with all-gaseous operation.

The system 100 may be configured to provide a predetermined average amount of power for a predetermined amount of time. For example, the tank 108, the engines 302 and 34, and the generator(s) 106 may be sized accordingly. Alternatively or in addition, combustors 202 and/or expanders may be added to the system 100 as needed in order to optimize a duty cycle for an application.

In some examples, the engine(s) 302 and 304 may supply power to and/or provide propulsion for an aircraft. Examples of the aircraft may include a helicopter, an airplane, an unmanned space vehicle, a fixed wing vehicle, a variable wing vehicle, a rotary wing vehicle, an unmanned combat aerial vehicle, a tailless aircraft, a hover craft, and any other airborne and/or extraterrestrial (spacecraft) vehicle. Alternatively or in addition, the engine 302 and 304 may be utilized in a configuration unrelated to powering the aircraft.

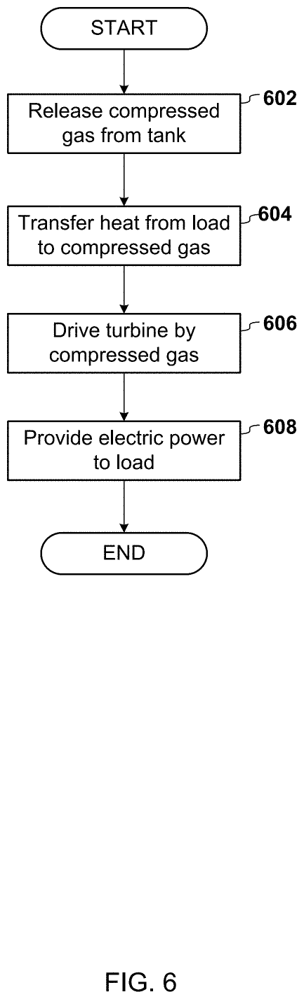

FIG. 6 illustrates a flow diagram of example steps for providing power and thermal management. The steps may include additional, different, or fewer steps than illustrated in FIG. 6. The steps may be executed in a different order than illustrated in FIG. 6.

Compressed gas may be released (602) from the tank 108 into the heat exchanger 112. For example, the compressed gas may flow through the expansion valve 110 into the heat exchanger 112 downstream of the expansion valve 110.

Heat from the load 102 may be transferred (604) to the compressed gas. For example, heat may be transferred to the compressed gas in the heat exchanger 112 via the coolant loop 114.

The turbine 104 may be driven (606) by the compressed gas. For example, the compressed gas that is heated in the heat exchanger 112 may be directed to flow past the blades of the turbine 104.

The electric generator 106 may be mechanically powered (608) by the turbine 104. For example, the turbine 104 may turn a shaft that rotates coils in the electric generator 106.

Electric power generated by the electric generator 106 may be provided (610) to the load 102 as a primary power source. The steps illustrated in FIG. 6 may be performed in parallel as the load 102 is continuously powered and cooled by the system 100.

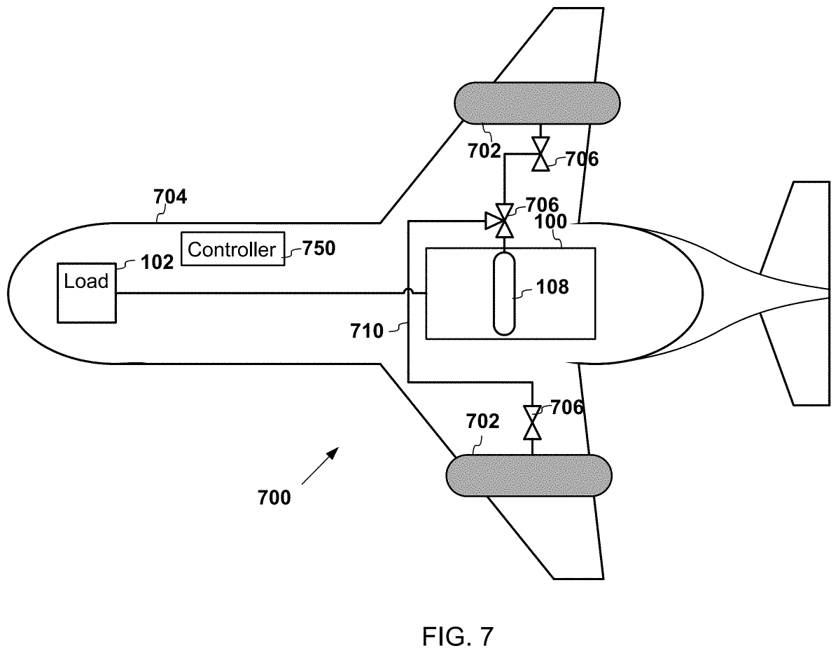

FIG. 7 is a schematic diagram of an example of an anti-surge and relight system 700 for one or more gas turbine engines 702 of an aircraft 704. The anti-surge and relight system 700 shown in FIG. 7 includes the compressed gas power and thermal management system 100, which includes the tank 108 of compressed gas. The anti-surge and relight system 700 also includes a control and compressed gas distribution system comprising a controller 750, valves 706, and conduits 710 fluidly connecting one or more of the valves 706 with the tank 108 of compressed gas and/or the gas turbine engines 702 of the aircraft 704. The distribution system may include additional, fewer, and/or different components than in the example shown in FIG. 7.

The gas turbine engines 702 are prime power engines for the aircraft 704.

The anti-surge and relight system 700 may leverage the tank 108 of compressed gas that is in the compressed gas power and thermal management system 100.

Each of the gas turbine engines 702 may be a prime power engine. A prime power engine is any engine configured to provide the primary propulsion power during typical operation of the aircraft 704. In contrast, an engine that is included in an auxiliary power unit or an emergency power unit either typically does not run and/or is not used for primary propulsion power.

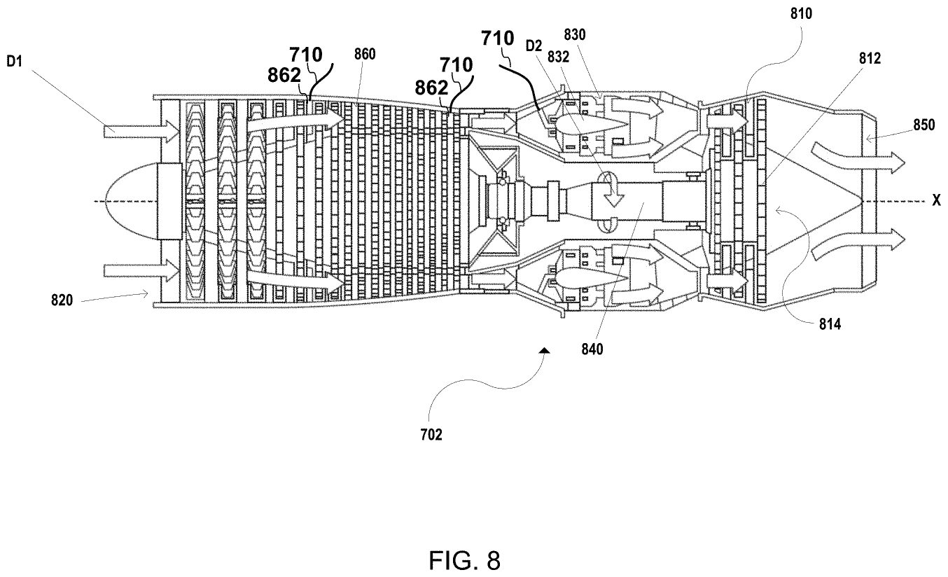

FIG. 8 is a cross-sectional view of an example of one of the gas turbine engines 702 shown in FIG. 7. The gas turbine engine 702 may take a variety of forms in various embodiments. Though depicted as an axial flow engine, in some forms the gas turbine engine 702 may have multiple spools and/or may be a centrifugal or mixed centrifugal/axial flow engine. In some forms, the gas turbine engine 702 may be a turboprop, a turbofan, or a turboshaft engine. Furthermore, the gas turbine engine 702 may be an adaptive cycle and/or variable cycle engine. Other variations are also contemplated.

The gas turbine engine 702 may include an intake section 820, a compressor 860, a combustion section 830, a turbine section 810, and an exhaust section 850. During operation of the gas turbine engine 702, fluid received from the intake section 820, such as air, travels along the direction D1 and may be compressed by the compressor 860. The compressed fluid may then be mixed with fuel and the mixture may be burned in the combustion section 830. The combustion section 830 may include any suitable fuel injection and combustion mechanisms. The hot, high pressure fluid may then pass through the turbine section 810 to extract energy from the fluid and cause a turbine shaft of a turbine 814 in the turbine section 810 to rotate, which in turn drives the compressor 860. Discharge fluid may exit the exhaust section 850.

As noted above, the hot, high pressure fluid passes through the turbine section 810 during operation of the gas turbine engine 702. As the fluid flows through the turbine section 810, the fluid passes between adjacent blades 812 of the turbine 814 causing the turbine 814 to rotate. The rotating turbine 814 may turn a shaft 840 in a rotational direction D2, for example. The blades 812 may rotate around an axis of rotation, which may correspond to a centerline X of the turbine 814 in some examples.

Referring to both FIGS. 7 and 8, the control and compressed gas distribution system is configured to distribute compressed air from the tank 108 via the one or more conduits 710 to one or more combustors 832 of the gas turbine engine(s) 702 and/or to one or more locations 862 in the compressor 860 of the gas turbine engine(s) 702. The controller 750 may be configured to cause compressed gas from the tank 108 to be injected into the compressor 860 of the gas turbine engine 702 via the one or more conduits 710 in response to detection of a compressor surge and/or a potential compressor surge. The controller 750 may use any currently known or later discovered technique for detecting the compressor surge or potential compressor surge. For example, the controller 750 may determine from sensor feedback that the compressor 860 is operating within a predetermined distance of the surge line and detect, as result, the existence of a potential compressor surge. As another example, the controller 750 may determine from sensor feedback that the compressor 860 is operating in a surge region and detect, as a result, that the compressor 860 is experiencing a compressor surge.

The compressor 860 of the gas turbine engine 702 may be configured to selectively receive the compressed gas from the tank 108 at the multiple locations 862 of the compressor 860, such as at inlets of stations of the compressor 860. For example, one or more of the valves 706 may control a flow of the compressed gas to each of the locations 862. The controller 750 may selectively control, for example, the pressure gradient across any of the stations by causing the compressed air from the tank 108 to be injected at the corresponding inlet of the station, thereby increasing the pressure at the corresponding inlet. Alternatively or in addition, the controller 750 may be configured to cause gas to be vented away from a corresponding outlet of the station, thereby decreasing the pressure at the corresponding outlet of the station.

Each of the stations may include a set of stators and a set of blades. Alternatively or in addition, each of the stations may include a stage of the compressor 860.

Alternatively or in addition, the combustor 832 may be configured to receive compressed gas from the tank 108. The compressed gas may be received by the combustor 832 in response to an engine startup command. The engine startup command may be any signal indicating that the gas turbine engine 702 is to be relit, restarted, and/or started. The engine startup command may be automatically generated based on sensor input and/or generated in response to input received from a human, such as a pilot. The engine startup command may be generated, for example, in response to a flame out experienced in-flight.

During startup of the gas turbine engine 702, the controller 750 may monitor the compressor 860 for a compressor surge and/or a potential compressor surge in a manner described above. In a manner described above, the controller 750 may inject compressed gas into and/or release gas from the compressor 860 to help avoid compressor surge.

In some examples, the anti-surge and relight system 700 may include an air start turbine (not shown). The air start turbine may be any apparatus that includes a turbine driven by air that is configured to rotate a rotor, such as the shaft 840, of the gas turbine engine 702 on startup of the gas turbine engine 702. As a result of the rotation of the rotor, the compressor 860 may provide enough compressed gas to the combustion section 830 that the gas turbine engine 702 may be restarted. When the aircraft 704 is on the ground, the air start turbine may be supplied compressed air from a device designed for this purpose. Alternatively or in addition, the air start turbine may be driven by compressed air received from the tank 108. The compressed air may be received by the air start turbine from the tank 108 in-flight.

Alternatively or in addition, the controller 750 may be configured to cause the compressed gas from the tank 108 to be injected into the compressor 860 of the gas turbine engine 702 on startup of the gas turbine engine 702. For example, the compressed air may be blown on blades of the compressor 860 in a manner and direction that causes the rotor to accelerate and increase compression during light off.

Alternatively or in addition, the anti-surge and relight system 700 may include an electric start engine (not shown). The electric start engine may be any electric motor configured to rotate a rotor, such as the shaft 840, of the gas turbine engine 702 on startup of the gas turbine engine 702. When the aircraft 704 is on the ground, the electric start engine may receive electric power from a generator that is external to the aircraft 704. Alternatively or in addition, the electric start engine may be configured to receive electric power from the generator 106 of the compressed gas power and thermal management system 100. Accordingly, the generator 106 may power the electric start engine in-flight to enable a startup of the gas turbine engine 702.

The gas turbine engine 702 may be configured as a prime power engine for the aircraft 704. Alternatively, the gas turbine engine 702 may be a component of an auxiliary power unit and/or an emergency power unit.

The tank 108 may be replenished using one or more mechanisms. For example, the tank 108 may be configured to receive compressed gas from a second aircraft in-flight. For example, instead of—or in addition to—receiving jet fuel from a tanker aircraft, the tank 108 in the aircraft 704 may receive compressed air from the tanker aircraft.

Alternatively or in addition, the tank 108 may be configured to receive compressor bleed air, ram air, and/or compressed gas from any other compressed gas source that is external to the aircraft.

In some examples, the controller 750 may be configured to cause the compressed gas to be injected in the combustor 832 and/or the compressor 860 from the tank 108 instead from an active compressed gas source due to a failure of the active compressed gas source. An active compressed gas source includes a compressor that compresses a gas via application of mechanical and/or electrical power.

The example of the aircraft 704 illustrated in FIG. 7 is an airplane. Examples of the aircraft 704 include an airplane, a helicopter, an unmanned space vehicle, a fixed wing vehicle, a variable wing vehicle, a rotary wing vehicle, an unmanned combat aerial vehicle, a tailless aircraft, a hover craft, and any other airborne and/or extraterrestrial (spacecraft) vehicle.

The anti-surge and relight system 700 may be implemented in many different ways. For example, the system 700 may be configured as only a relight system. In another example, the system 700 may be configured as only an anti-surge system. In still another example, the system 700 may be configured as both an anti-surge system and a relight system.

The example of the anti-surge and relight system 700 shown in FIG. 7 relies on the compressed gas power and thermal management system 100. Alternatively or in addition, the anti-surge and relight system 700 may rely on any auxiliary system that includes the tank 108 of compressed gas. In fact, the anti-surge and relight system 700 may rely on a system that only includes the tank 108 of compressed gas.

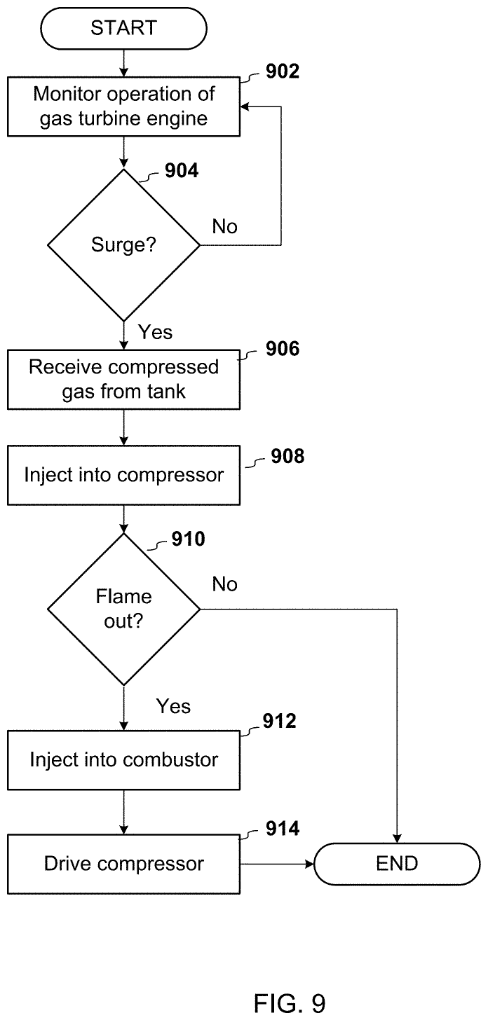

FIG. 9 illustrates a flow diagram of example steps for avoiding compressor surge, recovering from compressor surge and/or starting the gas turbine engine 702. The steps may be executed in a different order than illustrated in FIG. 9.

The steps may begin by monitoring (902) the operation of the gas turbine engine 702. For example, the mass flow rate through the compressor 860 and the pressure ratio across the compressor 860 and/or across one or more stations of the compressor 860 may be monitored.

A determination (904) may be made whether a compressor surge and/or a potential compressor surge in the gas turbine engine 702 of the aircraft 704 is detected. For example, if the operation of compressor 860 mapped to the compressor operating map falls within a compressor surge region or within a predetermined area adjacent to the compressor surge region, then a compressor surge or a potential compressor surge respectively may be detected. If no compressor surge and no potential compressor surge is detected, then the operation of the gas turbine engine 702 may continue to be monitored (902).

Alternatively, if a compressor surge or a potential compressor surge is detected, then compressed gas from the tank 108 located in the aircraft 704 may be received (906) at the compressor 860 of the gas turbine engine 702.

Next, the compressed gas received from the tank 108 may be injected (908) into the compressor 860 of the gas turbine engine 702 in response to detection of the compressor surge and/or the potential compressor surge. For example, the compressed gas may be selectively injected into any of a plurality of stations of the compressor in which a pressure ratio is to be lowered in order to avoid or recover from a compressor surge.

The combustor(s) 832 of the gas turbine engine 702 may be monitored for a flame out. If a flame out is not detected, then operations may end by, for example, continuing to monitor (902) the operating of the gas turbine engine 702. Alternatively, if a flame out is detected (910), then compressed gas from the tank 108 may be injected (912) into the combustor(s) 832. There, the compressed gas may be mixed with fuel and burned. Alternatively or in addition, compressed gas from the tank 108 may drive (914) the compressor 860. For example, the controller 750 may cause the compressed air to flow past and/or against blades of the compressor 860. As another example, the compressed gas from the tank 108 may drive the air start turbine, which causes the compressor 860 to rotate and the gas turbine engine 702 to startup.

Operations may end, by for example, continuing to monitor (902) the operating of the gas turbine engine 702.

The steps may include additional, different, or fewer steps than illustrated in FIG. 9. For example, only steps related to compressor surge may be performed. In an alternative example, only steps related to detecting and addressing a flame out are performed.

To clarify the use of and to hereby provide notice to the public, the phrases “at least one of <A>, <B>, . . . and <N>” or “at least one of <A>, <B>, <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

What is claimed is:

1. An anti-surge system comprising:
a tank of compressed gas included in an aircraft;
a gas turbine engine included in the aircraft; and
a controller configured to cause compressed gas from the tank to be injected into a compressor of the gas turbine engine in response to detection of a compressor surge and/or a potential compressor surge.

2. The anti-surge system of claim 1, wherein the compressor of the gas turbine engine is configured to selectively receive the compressed gas at a plurality of stations of the compressor, and the controller is configured to selectively control a pressure gradient across any of the stations.

3. The anti-surge system of claim 1, wherein the gas turbine engine is configured as a prime power engine for the aircraft.

4. The anti-surge system of claim 1, wherein a combustor is configured to receive compressed gas from the tank delivered in response to an engine startup command.

5. The anti-surge system of claim 1 further comprising an air start turbine configured to be driven by compressed air from the tank and to rotate a rotor of the gas turbine engine on startup of the gas turbine engine.

6. The anti-surge system of claim 5, wherein the controller is configured to cause the compressed gas from the tank to be injected into the compressor of the gas turbine engine on startup of the gas turbine engine.

7. The anti-surge system of claim 1, wherein the aircraft is a first aircraft and the tank is configured to receive compressed gas from a second aircraft in-flight.

8. The anti-surge system of claim 1, wherein the tank is configured to receive compressor bleed air, ram air, and/or a compressed gas from a compressed gas source that is external to the aircraft.

9. A relight system comprising:
a tank of compressed gas included in an aircraft; and
a gas turbine engine configured as a prime power engine for the aircraft, the gas turbine engine comprising a combustor and a compressor, wherein the combustor and/or the compressor is configured to receive compressed air from the tank during a startup of the gas turbine engine.

10. The relight system of claim 9, wherein the combustor is configured to receive the compressed air from the tank during the startup in response to detection of a flame out.

11. The relight system of claim 9, wherein the compressor is configured to receive the compressed air from the tank during the startup in response to detection of a flame out.

12. The relight system of claim 9 further comprising an air start turbine configured to be driven by compressed gas released from the tank.

13. The relight system of claim 9 further comprising a controller configured to detect a compressor surge and/or a potential compressor surge and to recover a pressure ratio in the compressor via an injection of compressed air from the tank into the compressor during the startup.

14. The relight system of claim 9 further comprising an electric start engine, a turbine and a generator, wherein the electric start engine is configured to start the gas turbine engine and be electrically powered by the generator, the generator is configured to be mechanically power by the turbine, and the turbine is configured to be powered by compressed gas received from the tank.

15. A method comprising:
detecting a compressor surge and/or a potential compressor surge in a gas turbine engine of an aircraft;
receiving compressed gas from a tank located in the aircraft; and
injecting the compressed gas received from the tank into a compressor of the gas turbine engine in response to detection of the compressor surge and/or the potential compressor surge.

16. The method of claim 15, wherein injecting the compressed gas comprises selectively injecting the compressed gas into any of a plurality of stations of the compressor in which a pressure ratio is to be lowered.

17. The method of claim 15, wherein the detecting, the receiving, and the injecting are performed at an altitude higher than 30,000 feet.

18. The method of claim 15, wherein detection of the compressor surge and/or the potential compressor surge occurs during startup of the gas turbine engine.

19. The method of claim 18 further comprising injecting compressed gas from the tank into a combustor in response to detection of a flame out.

20. The method of claim 15, wherein the gas turbine engine is configured as a prime power engine for the aircraft.
